(19) United States
(12) Patent Application Publication
(10) Pub. No.: US 2019/0266085 A1
(43) Pub. Date: Aug. 29, 2019

(54) MEMORY SYSTEM AND OPERATION METHOD THEREOF

(71) Applicant: SK hynix Inc., Gyeonggi-do (KR)

(72) Inventors: Jong-Min LEE, Seoul (KR); Beom-Rae JEONG, Gyeonggi-do (KR)

(21) Appl. No.: 16/179,362

(22) Filed: Nov. 2, 2018

(30) Foreign Application Priority Data
Feb. 26, 2018 (KR) 10-2018-0022709

(51) Int. Cl. G06F 12/0804

(52) U.S. Cl. CPC G06F 12/0804; G06F 2212/205; G06F 2212/1008

(57) ABSTRACT

A memory system may include: a nonvolatile memory comprising a plurality of memory blocks, each including a plurality of pages; a volatile memory suitable for temporarily storing data transferred between a host and the nonvolatile memory; and a controller suitable for determining whether to start or end an automatic exclusive mode in response to a request from the host or a result obtained by checking a state of the nonvolatile memory, repeatedly entering into, or exiting from, the automatic exclusive mode in each set cycle when the automatic exclusive mode is started, and exclusively using the volatile memory to perform a merge operation on the nonvolatile memory during an entry period of the automatic exclusive mode in each set cycle.

### CROSS-REFERENCE TO RELATED APPLICATION

This application claims priority under 35 U.S.C. § 119 to Korean Patent Application No. 10-2018-0022709, filed on Feb. 26, 2018, which is incorporated herein by reference in its entirety.

### BACKGROUND

### 1. Field

Various embodiments relate to a memory system, and more particularly, to a memory system which supports a merge operation, and an operation method thereof.

### 2. Discussion of the Related Art

The computer environment paradigm has shifted to ubiquitous computing systems that can be used anytime and anywhere. As a result use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts, as compared with a hard disk device. Examples of memory systems having such advantages include universal serial bus (USB) memory devices, memory cards having various interfaces, and solid state drives (SSD).

### SUMMARY

Various embodiments are directed to a memory system capable of enhancing or maximizing the performance of a merge operation, and an operation method thereof.

In an embodiment, a memory system may include: a nonvolatile memory comprising a plurality of memory blocks, each including a plurality of pages; a volatile memory suitable for temporarily storing data transferred between a host and the nonvolatile memory; and a controller suitable for determining whether to start or end an automatic exclusive mode in response to a request from the host or a result obtained by checking a state of the nonvolatile memory, repeatedly entering into, or exiting from, the automatic exclusive mode in each set cycle when the automatic exclusive mode is started, and exclusively using the volatile memory to perform a merge operation on the nonvolatile memory during an entry period of the automatic exclusive mode in each set cycle.

The memory system may further include an information storage suitable for storing first information on start and end states of the automatic exclusive mode, second information on the set cycle, and third information on the length of the entry period of the automatic exclusive mode.

The controller may include: a host controller suitable for processing an operation between the host and the host controller; a memory controller coupled to the host controller, and suitable for processing an operation between the nonvolatile memory and the memory controller, and the memory controller may adjust values of the first to third information in response to the request of the host or the result obtained by checking the state of the nonvolatile memory.

The memory controller may check the ratio of free memory blocks among the memory blocks, and may set the first information to a start state when the ratio of free memory blocks is equal to or less than a set ratio, and may set the first information to an end state when the ratio of free memory blocks exceeds the set ratio.

The host controller may request the memory controller to start the automatic exclusive mode in response to a request for the merge operation from the host, and the memory controller may set the first information to the start state in response to the request from the host controller.

The memory controller may check a total number of valid pages in victim memory blocks among the memory blocks when performing the merge operation at the start of the automatic exclusive mode, when the total number of valid pages is equal to or more than a set number, the memory controller may adjust the second information such that the set cycle is more frequently repeated, or may adjust the third information to increase the length of the entry period of the automatic exclusive mode, and when the total number of valid pages is less than the set number, the memory controller may adjust the second information such that the set cycle is less frequently repeated, or may adjust the third information to decrease the length of the entry period of the automatic exclusive mode.

The host controller may check the first to third information, and may inform the host of a switchover to a busy state in response to an entry into the automatic exclusive mode based on the check result, or may inform the host of a switchover to a ready state in response to an exit from the automatic exclusive mode based on the check result.

The memory controller may check the first to third information, may repeatedly enter into, and may exit from, the automatic exclusive mode in each set cycle based on the check result, and may exclusively use the nonvolatile memory to perform the merge operation on the nonvolatile memory during the entry period of the automatic exclusive mode in each set cycle.

The memory controller may flush the data stored in the volatile memory to the nonvolatile memory in response to entry into the automatic exclusive mode, and may exclusively use the volatile memory to perform the merge operation on the nonvolatile memory during the entry period of the automatic exclusive mode in each set cycle.

The memory controller may discard data updated into the nonvolatile memory among the data stored in the volatile memory in response to entry into the automatic exclusive mode, and may exclusively use the volatile memory to perform the merge operation on the nonvolatile memory during the entry period of the automatic exclusive mode in each set cycle.

In an embodiment, an operation method of a memory system which includes a nonvolatile memory including a plurality of blocks, each having a plurality of pages, and a volatile memory for temporarily storing data transferred between a host and the nonvolatile memory, the operation method may include: determining whether to start or end an automatic exclusive mode in response to a request from the host or a result obtained by checking a state of the nonvolatile memory, and repeatedly entering into, and exiting from, the automatic exclusive mode in each set cycle when the automatic exclusive mode is started; and exclusively using the volatile memory to perform a merge operation on the nonvolatile memory during the entry period of the automatic exclusive mode in each set cycle.

The memory system may further include an information storage suitable for storing first information on start and end states of the automatic exclusive mode, second information on the set cycle, and third information on the length of the entry period of the automatic exclusive mode.

The memory system may further include a host controller suitable for processing an operation between the host and the host controller and a memory controller coupled to the host controller and suitable for processing an operation between the nonvolatile memory and the memory controller, and the determining step may include adjusting the first to third information through the memory controller in response to the request of the host or the result obtained by checking the state of the nonvolatile memory.

The adjusting step may include: checking the ratio of free memory blocks among the memory blocks; setting the first information to the start state by the memory controller, when the ratio of free memory blocks is equal to or less than a set ratio; and setting the first information to the end state by the memory controller, when the ratio of free memory blocks exceeds the set ratio.

The determining step may further include requesting, by the host controller, the memory controller to start the automatic exclusive mode, when the host requests the host controller to perform the merge operation, and the adjusting step further comprises setting the first information to the start state by the memory controller in response to the requesting step.

The adjusting step may include: checking the total number of valid pages in victim memory blocks among the memory blocks when performing the merge operation by the memory controller at the start of the automatic exclusive mode; adjusting the second information by the memory controller such that the set cycle is more frequently repeated, or adjusting the third information to increase the length of the entry period of the automatic exclusive mode, when the total number of valid pages is equal to or more than a set number; and adjusting the second information by the memory controller such that the set cycle is less frequently repeated, or adjusting the third information to decrease the length of the entry period of the automatic exclusive mode, when the total number of valid pages is less than the set number.

The determining step may include: checking the first to third information; informing, by the host controller, the host that the is memory system is switched to a busy state, in response to an entry into the automatic exclusive mode based on the result of checking the first to third information; and informing, by the host controller, the host that the memory system is switched to a ready state, in response to an exit from the automatic exclusive mode based on the result of checking the first to third information.

The determining step may include: checking, by the memory controller, the first to third information; and performing a repeating step in which the memory controller repeatedly enters into, and exits from the automatic exclusive mode in each set cycle at the start of the automatic exclusive mode based on the checking of the first to third information.

The operation method may further include performing, by the memory controller, the exclusively using step after flushing the data stored in the volatile memory to the nonvolatile memory in response to the entry into the automatic exclusive mode in each set cycle through the repeating step.

The operation method may further include performing, by the memory controller, the exclusively using step after discarding data updated into the nonvolatile memory among data stored in the volatile memory in response to the entry into the automatic exclusive mode in each set cycle through the repeating step.

In an embodiment, a memory system may include: a nonvolatile memory comprising a plurality of memory blocks, each is including a plurality of pages; a volatile memory suitable for temporarily storing data read from, or programmed into, the nonvolatile memory; and a controller suitable for determining whether to start or end an automatic exclusive mode, in which the volatile memory is configured for a merge operation, in each of a plurality of periods, in response to at least one of an entered request or a status of the nonvolatile memory, the volatile memory may be configured for the merge operation at a first entry of the automatic exclusive mode in a first of the plurality of periods.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system in accordance with an embodiment of the present invention;

FIG. 2 is a schematic diagram illustrating an exemplary configuration of a memory device employed in the memory system shown in FIG. 1;

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2;

FIGS. 5 to 7 are diagrams for describing a memory system in accordance with an embodiment; and

FIGS. 8 to 16 are diagrams schematically illustrating application examples of the data processing system shown in FIG. 1 in accordance with various embodiments of the present invention.

### DETAILED DESCRIPTION

Various embodiments of the present invention are described below in more detail with reference to the accompanying drawings. However, elements and features of the present invention may be configured or arranged differently than depicted in the disclosed embodiments to form different embodiments and variations of disclosed embodiments. Accordingly, the present invention is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and embodiments of the present invention. Moreover, throughout the specification, reference to “an embodiment,” “another embodiment,” or the like is not necessarily to only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element described below could also be termed as a second or third element without departing from the spirit and scope of the present invention.

The drawings are not necessarily to scale and, in some instances, proportions may have been exaggerated to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments and is not intended to be limiting of the present invention. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements but do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

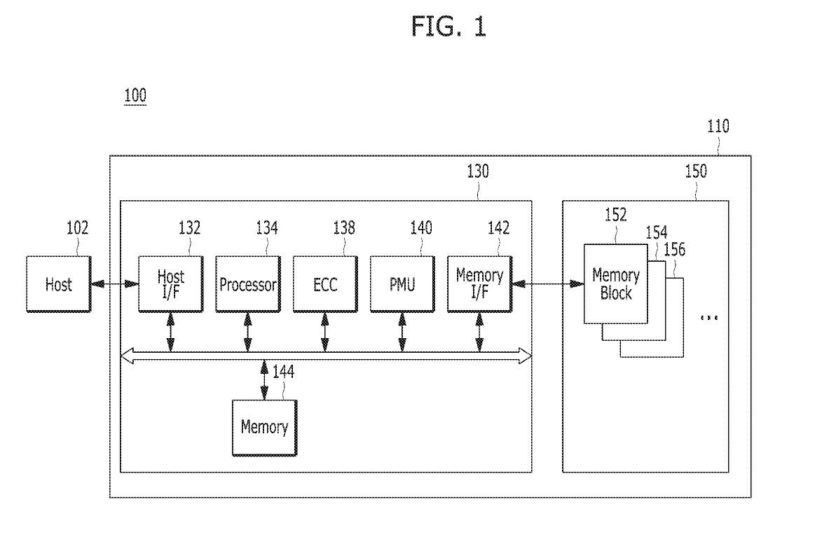

FIG. 1 is a block diagram illustrating a data processing system 100 including a memory system 110 in accordance with an embodiment of the present invention.

Referring to FIG. 1, the data processing system 100 may include a host 102 and the memory system 110.

The host 102 may include portable electronic devices such as a mobile phone, MP3 player and laptop computer or non-portable electronic devices such as a desktop computer, a game machine, a TV and a projector.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limiting examples of storage devices in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM) and a flash memory. The flash memory may have a 3-dimensioanl (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limiting exemplary applications of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and may provide data stored therein to the host 102 through a read operation. The memory device 150 may include a plurality of memory dies (not shown), each memory die including a plurality of planes (not shown), each plane including a plurality of memory blocks 152 to 156, each of which may include a plurality of pages. Each of the pages may include a plurality of memory cells coupled to a word line.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) 132, a processor 134, an error correction code (ECC) component 138, a Power Management Unit (PMU) 140, a NAND flash controller (NFC) 142 and a memory 144, all operatively coupled via an internal bus.

The host interface 132 may be configured to process a command and data of the host 102, and may communicate with the host 102 according to one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (DATA), enhanced small disk interface (ESDI) and integrated drive electronics (IDE).

The ECC component 138 may detect and correct an error contained in the data read from the memory device 150. In other words, the ECC component 138 may perform an error correction decoding process to the data read from the memory device 150 through an ECC code used during an ECC encoding process.

According to a result of the error correction decoding process, the ECC component 138 may output a signal, for example, an error correction success or fail signal. When the number of error bits is more than a threshold value of correctable error bits, the ECC component 138 may not correct the error bits, and instead may output an error correction fail signal.

The ECC component 138 may perform error correction through a coded modulation such as Low Density Parity Check (LDDC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC component 138 is not limited to these error correction techniques. As such, the ECC component 138 may include all circuits, modules, systems or devices for suitable error correction.

The PMU 140 may manage electrical power used by and provided to the controller 130.

The NFC 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the NFC 142 may generate a control signal for the memory device 150 to process data provided to the memory device 150 under the control of the processor 134. The NFC 142 may work as an interface (e.g., a NAND flash interface) for processing a command and data between the controller 130 and the memory device 150. Specifically, the NFC 142 may support data transfer between the controller 130 and the memory device 150.

The memory 144 may serve as a working memory of the memory system 110 and the controller 130. The memory 144 may store data supporting operations of the memory system 110 and the controller 130. The controller 130 may control the memory device 150 to perform read, write, program and erase operations in response to a request from the host 102. The controller 130 may output data read from the memory device 150 to the host 102, and may store data provided from the host 102 into the memory device 150. The memory 144 may store data required for the controller 130 and the memory device 150 to perform these operations.

The memory 144 may be embodied by a volatile memory. For example, the memory 144 may be embodied by a static random access memory (SRAM) or a dynamic random access memory (DRAM). The memory 144 may be disposed within or out of the controller 130. FIG. 1 illustrates an example of the memory 144 disposed within the controller 130. In another embodiment, the memory 144 may be an external volatile memory having a memory interface for transferring data between the memory 144 and the controller 130.

The processor 134 may control the overall operations of the memory system 110. The processor 134 may use firmware to control the overall operations of the memory system 110. The firmware may be referred to as a flash translation layer (FTL).

The processor 134 of the controller 130 may include a management unit (not illustrated) for performing a bad management operation of the memory device 150. The management unit may perform a bad block management operation of checking a bad block, among the plurality of memory blocks 152 to 156 in the memory device 150. The bad block may be one in which a program fail occurs during a program operation due to a characteristic of a NAND flash memory. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

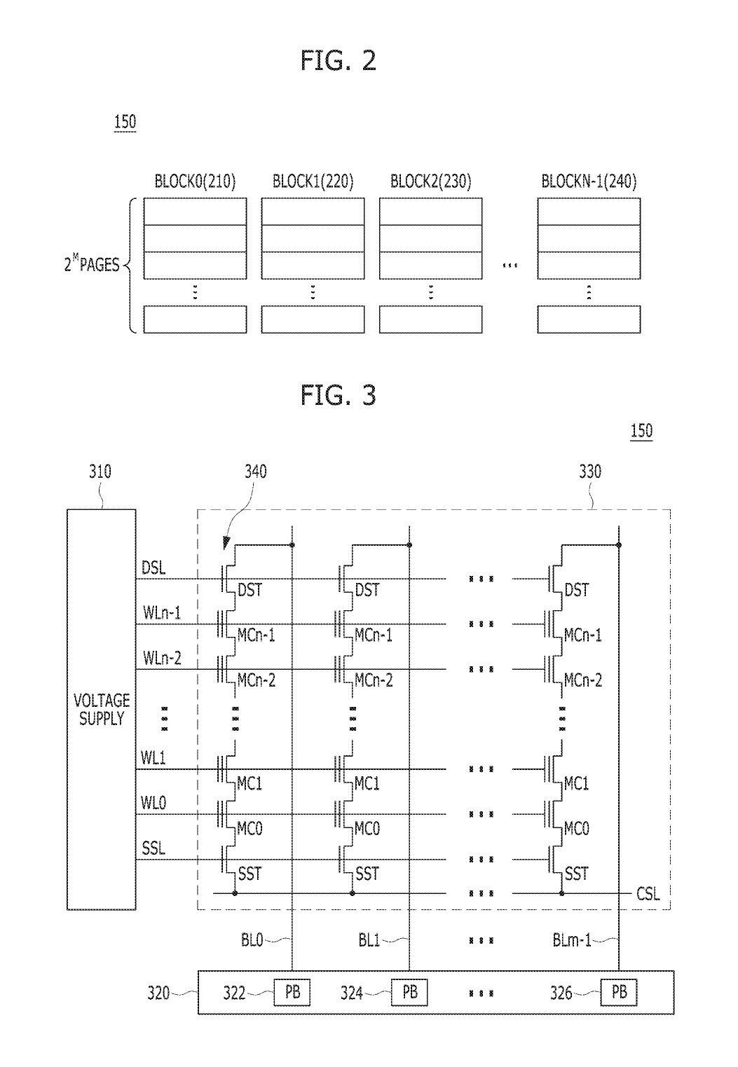

FIG. 2 is a schematic diagram illustrating the memory device 150.

Referring to FIG. 2, the memory device 150 may include a plurality of memory blocks, e.g., BLOCK0 210, BLOCK1 220, BLOCK2 230, and BLOCKN-1 240, each of which may include a plurality of pages, for example, 2^{M} pages, the number of which may vary according to circuit design. Memory cells included in the respective memory blocks 0 to N−1 may be one or more of a single level cell (SLC) storing 1-bit data, or a multi-level cell (MLC) storing 2- or more bit data. In an embodiment, the memory device 150 may include a plurality of triple level cells (TLC) each storing 3-bit data. In another embodiment, the memory device may include a plurality of quadruple level cells (QLC) each storing 4-bit level cell.

FIG. 3 is a circuit diagram illustrating an exemplary configuration of a memory cell array of a memory block in the memory device 150.

Referring to FIG. 3, a memory block 330, which may correspond to any of the memory blocks 152 to 156 in the memory device 150, may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST, SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under such control, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and may supply a current or a voltage to bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

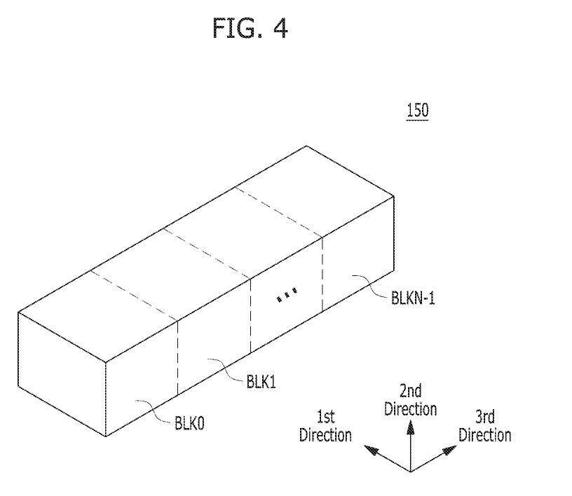

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1, each having a 3D structure (or vertical structure).

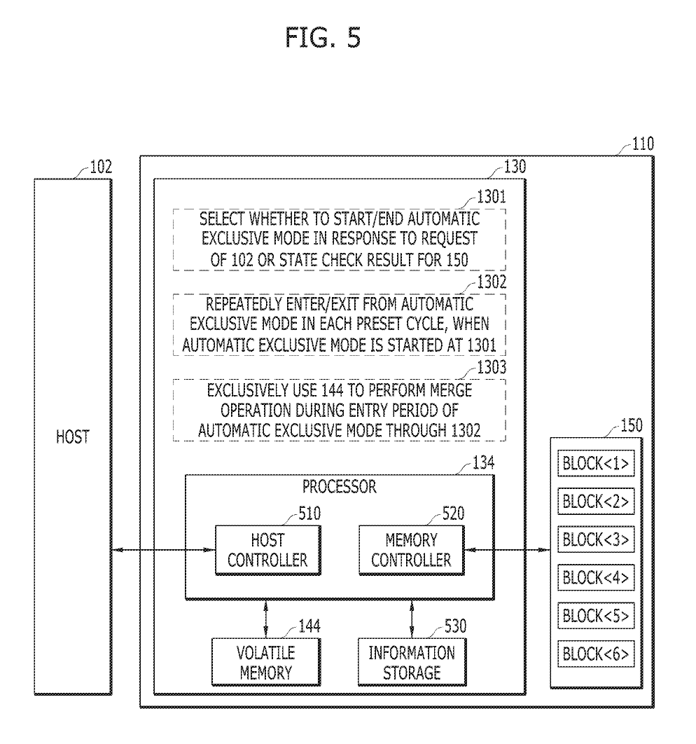

Detailed description will be made with reference to FIGS. 5 to 7 of data processing with respect to the memory device 150 in a memory system in accordance with an embodiment, particularly, a data processing operation of performing a command operation corresponding to a command received from the host 102 and a data management operation.

FIGS. 5 to 7 are diagrams for describing an operation of a memory system in accordance with an embodiment.

FIGS. 5 to 7 illustrate the configuration of a data processing system 100 including a host 102 and a memory system 110 with reference to the configuration of the data processing system 100 illustrated in FIG. 1.

As described with reference to FIG. 1, the memory system 110 may include a controller 130 and a nonvolatile memory 150.

The controller 130 may include a processor 134, a volatile memory 144 and an information storage 530. The processor 134 may include a host controller 510 and a memory controller 520.

As described with reference to FIG. 1, the nonvolatile memory 150 may include a plurality of memory blocks BLOCK<1:6>, each of which may include a plurality of pages as described with reference to FIG. 2.

For reference, FIGS. 5 to 7 illustrate that the memory system 110 includes only one nonvolatile memory 150. However, this configuration is only an example; a larger number of nonvolatile memories may be included in the memory system 110. Furthermore, FIGS. 5 to 7 illustrate that the nonvolatile memory 150 includes six memory blocks BLOCK<1:6>. However, this configuration is only an example; a larger number of memory blocks may be included in the nonvolatile memory 150.

FIG. 1 illustrates that the host interface 132, the ECC component 138, the power management unit 140 and the NAND flash controller 142 are included in the controller 130. That such elements are not illustrated in FIGS. 5 to 7 is for clarity of illustration. Such elements may be included in the controller 130.

Referring to FIG. 5, the nonvolatile memory 150 may include the plurality of memory blocks BLOCK<1:6>, each including a plurality of pages (not illustrated).

The volatile memory 144 may temporarily store data which are transferred between the host 102 and the nonvolatile memory 150.

The volatile memory 144 may correspond to the memory 144 described with reference to FIG. 1. The volatile memory 144 may be included in the controller 130 as illustrated in FIG. 5, or may be disposed externally to the controller 130.

The controller 130 may select whether to start/end an automatic exclusive mode in response to a request of the host 102 or a result obtained by checking the state of the nonvolatile memory 150, at operation 1301. In the automatic exclusive mode, the controller 130 may temporarily suspend or halt carrying out a request from the host 102 for an internal operation in the memory system 110.

When the automatic exclusive mode is started through operation 1301, the controller 130 may repeatedly enter in and/or exit from the automatic exclusive mode in each set or preset cycle, at operation 1302. That is, when the automatic exclusive mode is started through operation 1301, the controller 130 may enter the automatic exclusive mode in each set cycle, operate in the automatic exclusive mode for a set time (entry period of the automatic exclusive mode) in each cycle, and then exit from the automatic exclusive mode later in each cycle.

To perform a merge operation on the nonvolatile memory 150 in the entry period of the automatic exclusive mode through operations 1301 and 1302, the controller 130 may exclusively use the volatile memory 144 through operation 1303.

Then, the controller 130 may flush data stored in the volatile memory 144 into the nonvolatile memory 150 in response to the entry into the automatic exclusive mode through operation 1302 at the start time of the automatic exclusive mode through operation 1301.

In this case, the controller 130 can exclusively use the entire region of the volatile memory 144 to perform a merge operation during the entry period of the automatic exclusive mode.

The operation of flushing the data stored in the volatile memory 144 to the nonvolatile memory 150 may indicate that all of the data stored in the volatile memory 144 are copied and stored into a preset region of the nonvolatile memory 150. For this reason, the controller 130 may discard all of the data stored in the volatile memory 144 after the flush operation. The controller 130 may exclusively use the entire region of the volatile memory 144 in order to perform a merge operation.

Furthermore, the controller 130 may discard data updated into the nonvolatile memory 150 among the data stored in the volatile memory 144, in response to the entry into the automatic exclusive mode.

In this case, the controller 130 can exclusively use a wider region than a region designated for a general merge operation in the volatile memory 144, to perform a merge operation during the entry period of the automatic exclusive mode.

As described above with reference to FIG. 1, the volatile memory 144 can be used for various uses, for example, a write buffer/cache, a read buffer/cache and a map buffer/cache. Generally, the internal storage space of the volatile memory 144 may be divided into various regions depending on the uses. However, some of the internal storage space of the volatile memory 144 may be designated for a merge operation in advance.

The controller 130 in accordance with an embodiment may discard data updated into the nonvolatile memory 150 among data stored in the region which is not designated for a merge operation in the storage space of the volatile memory 144, in response to the entry into the automatic exclusive mode through operation 1302. Therefore, the controller 130 in accordance with an embodiment can exclusively use a wider region than the region designated for a general merge operation in the volatile memory 144, to perform a merge operation during the entry period of the automatic exclusive mode.

The data updated into the nonvolatile memory 150 among the data stored in the volatile memory 144 may indicate data which have been already stored into the nonvolatile memory 150 through an operation such as a checkpoint, among the data stored in the volatile memory 144. For this reason, the controller 130 can discard the data updated into the nonvolatile memory 150 among the data stored in the volatile memory 144 in the entry period of the automatic exclusive mode, and use the corresponding region (i.e., region previously storing discarded data and now ready to be reallocated) for a merge operation.

The controller 130 may switch the state of the memory system 110 to a busy state. The controller 130 may inform the host 102 of the switched state in response to the entry into the automatic exclusive mode.

Since the host 102 recognizes through the operation of the controller 130 that the memory system 110 is busy, the controller 130 may not receive an arbitrary request such as a read request or a write request from the host 102 for the entry period of the automatic exclusive mode through operation 1303.

Furthermore, the controller 130 may switch the state of the memory system 110 to a ready state and inform the host 102 of the switched state (i.e., the ready state), in response to an exit from the automatic exclusive mode.

Since the host 102 recognizes through the operation of the controller 130 that the memory system 110 is ready, the controller 130 may receive an arbitrary request such as a read request or a write request from the host 102 after exiting from the automatic exclusive mode through operation 1302.

The merge operation may include an operation of merging valid data included in two or more victim memory blocks among the is memory blocks BLOCK<1:6> in the nonvolatile memory 150, and an operation of moving the merged data to a target memory block.

For example, the merge operation may include or be a part of a garbage collection operation, a read reclaim operation, a wear leveling operation or a map update operation.

In the above-described operation 1301, the controller 130 may select whether to start the automatic exclusive mode depending on two conditions, such that entry into, or exit from, the automatic exclusive mode through operation 1302 can be carried out repeatedly.

According to the first condition of the controller 130 in operation 1301, the controller 130 may check the ratio of free memory blocks among the memory blocks BLOCK<1:6> in the nonvolatile memory 150. The controller 130 may determine whether to start the automatic exclusive mode depending on the check result.

When the check result of the first condition indicates that the ratio of free memory blocks is equal to or less than a set ratio, the controller 130 may continuously retain the automatic exclusive mode when the automatic exclusive mode was already started, or may start the automatic exclusive mode when the automatic exclusive mode was ended. Therefore, the entry into/exit from the automatic exclusive mode through operation 1302 can be repeated.

On the other hand, when the check result of the first condition indicates that the ratio of free memory blocks exceeds the set ratio, the controller 130 may end the automatic exclusive mode when the automatic exclusive mode was already started, or may continuously retain the end state of the automatic exclusive mode when the automatic exclusive mode was ended. Thus, the entry into/exit from the automatic exclusive mode through operation 1302 may not be repeated.

The first condition may indicate a case in which the controller 130 determines whether to start the automatic exclusive mode, such that the entry into/exit from the automatic exclusive mode can be repeated through operation 1302. The controller 130 may performs a merge operation in the entry period of the automatic exclusive mode.

According to the second condition of the controller 130 in operation 1301, the controller may select whether to start the automatic exclusive mode, when receiving a request for a merge operation from the host 102.

When the request for a merge operation is received from the host 102 in the second condition, the controller 130 may continuously retain the automatic exclusive mode in the case where the automatic exclusive mode was already started, or start the automatic exclusive mode in the case where the automatic exclusive mode was ended. Thus, the entry into/exit from the automatic exclusive mode through operation 1302 can be repeated.

The second condition may indicate a case in which, when a merge operation needs to be performed according to the request of the host 102, the controller 103 unconditionally starts the automatic exclusive mode to repeat the entry into/exit from the automatic exclusive mode through operation 1302, and performs the merge operation in the entry period of the automatic exclusive mode.

The information storage 530 may store first information corresponding to operation 1301 of the controller 130 as well as second and third information corresponding to operation 1302 of the controller 130.

The first information may contain information indicating whether the automatic exclusive mode was started or ended through operation 1301 of the controller 130.

The second information may contain information on a set cycle indicating repeated entry points of the automatic exclusive mode through operation 1302 of the controller 130, regarding the automatic exclusive mode started through operation 1301 of the controller 130.

The third information may contain information on the length of the entry period of the automatic exclusive mode, which indicates at which point the controller 130 will exit from the automatic exclusive mode after entering the automatic exclusive mode through operation 1302 of the controller 130, regarding the automatic exclusive mode started through operation 1301 of the controller 130.

The controller 130 may control the above-described operations 1301, 1302 by referring to the first to third information stored in the information storage 530.

That is, the controller 130 may check the first to third information stored in the information storage 530. The controller 130 may repeatedly enter/exit from the automatic exclusive mode in each set cycle, depending on the check result.

Specifically, the controller 130 may check whether the automatic exclusive mode was started, by referring to the first information stored in the information storage 530.

When the check result indicates that the automatic exclusive mode is not yet started or the automatic exclusive mode was ended, the controller 130 may determine whether to start the automatic exclusive mode through operation 1301. Furthermore, the controller 130 may perform the above-described operation 1301 to continuously retain the end state of the automatic exclusive mode.

When the check result indicates that the automatic exclusive mode was started, the controller 130 may perform operation 1301 to determine whether to end the automatic exclusive mode. Furthermore, the controller 130 may perform operation 1301 to continuously retain the automatic exclusive mode.

When the result obtained by checking the first information stored in the information storage 530 indicates that the automatic exclusive mode was started, the controller 130 may check the repeated entry and exit (timing) points of the automatic exclusive mode by referring to the second and third information. Therefore, according to the results obtained by checking the second and third is information stored in the information storage 530, the controller 130 may repeatedly enter the automatic exclusive mode through the operation 1302 at the repeated entry points of the automatic exclusive mode. Also, the controller 130 may repeatedly exit from the automatic exclusive mode through the operation 1302 at the repeated exit points.

The entry points of the automatic exclusive mode, defined by the second information stored in the information storage 530, may be decided based on a specific time interval which can be varied depending on the second information. For example, the specific time interval may be set in the range of 10 ms to 100 ms, depending on the second information.

The entry points of the automatic exclusive mode, defined by the second information stored in the information storage 530, may be decided based on a specific size of write data which are transferred from the host 102 and can be varied depending on the second information. For example, the specific size of the write data may be set in the range of 128 to 512 Kbyte, depending on the second information.

The controller 130 may adjust the values of the first to third information stored in the information storage 530, in response to at least one of a request of the host 102 or a result obtained by checking the state of the nonvolatile memory 150.

Specifically, the controller 130 may adjust the value of the first is information stored in the information storage 530 according to the first condition of operation 1301. That is, when the controller 130 needs to start the automatic exclusive mode according to the result obtained by checking the ratio of free memory blocks among the memory blocks BLOCK<1:6> included in the nonvolatile memory 150, the controller 130 may set the first information stored in the information storage 530 to the start state. Similarly, when the controller 130 needs to end the automatic exclusive mode according to the result obtained by checking the ratio of free memory blocks among the memory blocks BLOCK<1:6> included in the nonvolatile memory 150, the controller 130 may set the first information of the information storage 530 to the end state.

The controller 130 may adjust the value of the first information stored in the information storage 530 according to the second condition of the operation 1301. That is, when the controller 130 needs to start the automatic exclusive mode according to a request for a merge operation from the host 102, the controller 130 may set the first information of the information storage 530 to the start state.

Furthermore, according to the result obtained by checking the state of the nonvolatile memory 150 in the start period of the automatic exclusive mode, the controller 130 may adjust the second or third information stored in the information storage 530.

Specifically, when entering the automatic exclusive mode to perform a merge operation through operation 1302 in the start period of the automatic exclusive mode, the controller 130 may adjust the second or third information stored in the information storage 530 according to a result obtained by checking the total number of valid pages included in victim memory blocks among the memory blocks BLOCK<1:6> included in the nonvolatile memory 150.

During the merge operation, when the total number of valid pages in the victim memory blocks, among the memory blocks BLOCK<1:6> in the nonvolatile memory 150, is equal to or more than a set number (e.g., a threshold), the controller 130 may adjust the second information of the information storage 530, such that the entry point of the automatic exclusive mode through operation 1302, that is, the set cycle is more frequently repeated.

During the merge operation, when the total number of valid pages included in the victim memory blocks among the memory blocks BLOCK<1:6> in the nonvolatile memory 150 is less than the preset number, the controller 130 may adjust the second information stored in the information storage 530, such that the entry point of the automatic exclusive mode through operation 1302, that is, the set cycle is less frequently repeated.

During the merge operation, when the total number of valid pages in the victim memory blocks among the memory blocks BLOCK<1:6> in the nonvolatile memory 150 is equal to or more than the set number, the controller 130 may adjust the third information stored in the information storage 530 to increase the length of time of the automatic exclusive mode, i.e., from time of entry to time of exit, through operation 1302, that is, the length of the entry period of the automatic exclusive mode.

During the merge operation, when the total number of valid pages included in the victim memory blocks among the memory blocks BLOCK<1:6> included in the nonvolatile memory 150 is less than the preset number, the controller 130 may adjust the third information stored in the information storage 530 to decrease the length of the automatic exclusive mode from the entry point to the exit point through the operation 1302, that is, the length of the entry period of the automatic exclusive mode.

For reference, the controller 130 may adjust one or both of the second and third information stored in the information storage 530 through one adjusting operation. The adjusting operation of the controller 130 to adjust the second and/or third information of the information storage 530 may be changed depending on a designer's selection.

In the above-described embodiments, set ratio and set number have been used as reference values for adjusting at least one of the first to third information stored in the information storage 530. However, this is an example only, as more reference values can be used. For example, first to N ratios and first to M numbers can be used, where N and M are natural numbers larger than 2.

As illustrated in FIG. 5, the controller 130 may include the processor 134, and the processor 134 may include a host controller 510 and a memory controller 520. Therefore, the operations 1301, 1302, 1303 carried out by the controller 130 may be limited to operations of the host controller 510 and the memory controller 520 which are included in the processor 134 of the controller 130. However, this processing configuration is only an example. The operations 1301, 1302, 1303 of the controller 130 can be implemented through various other components, depending on a designer's selection.

The host controller 510 may process an operation between the host 102 and the host controller 510. For example, referring to FIG. 1, the host controller 510 and the memory controller 520 may be included in the processor 134 and coupled to each other. The host controller 510 may process an operation between the host 102 and the host controller 510 through the host interface 132.

The memory controller 520 may be coupled to the host controller 510. The memory controller 520 may carry out an operation between the nonvolatile memory 150 and the memory controller 520.

For example, referring to FIG. 1, the memory controller 520 and the host controller 510 may be included in the processor 134 and coupled to each other. The memory controller 520 may process an operation between the nonvolatile memory 150 and the memory controller 520 through the NAND flash controller 142.

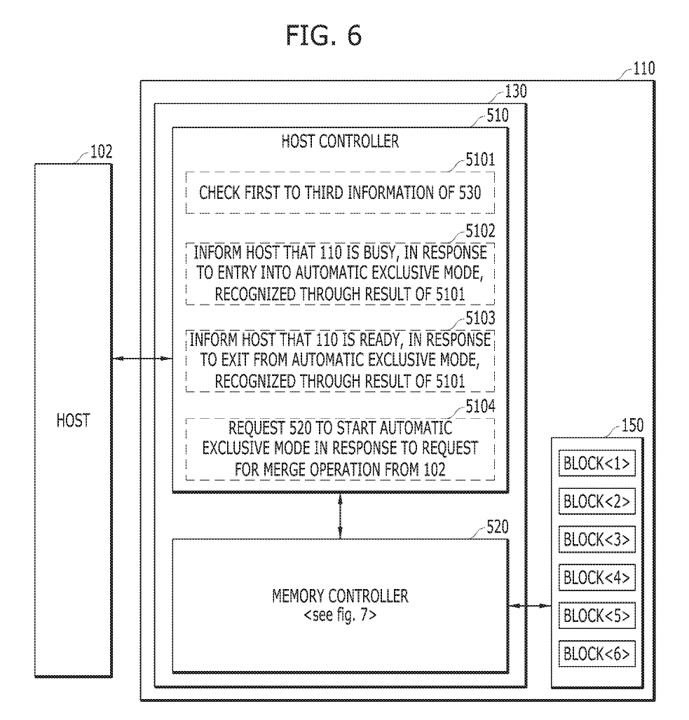

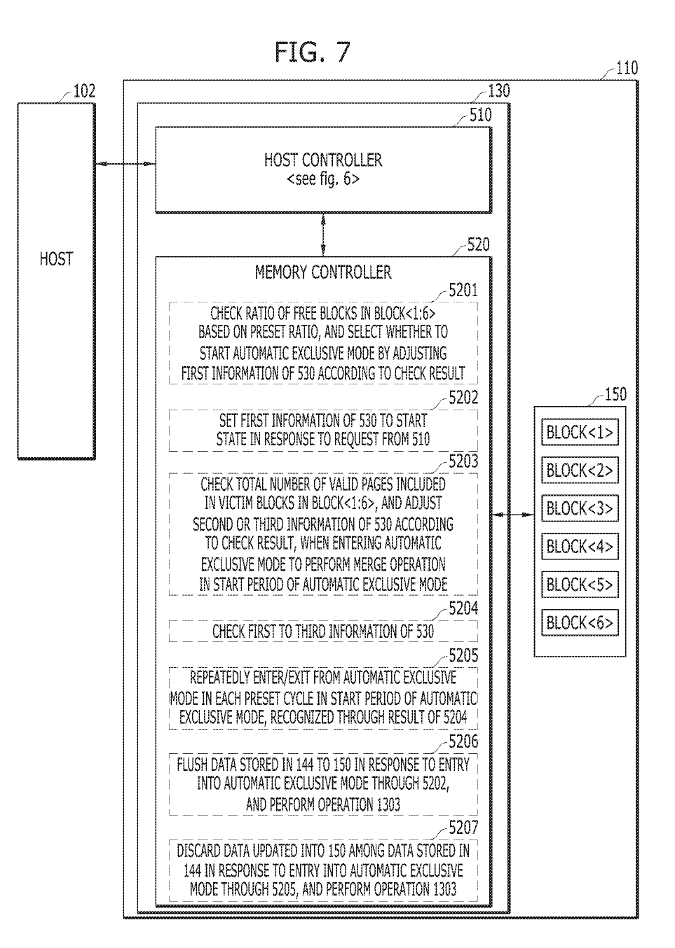

As illustrated in FIGS. 6 and 7, operations 1301 to 1303 performed by the controller 130 may be performed through operations of the host controller 510 and the memory controller 520 which are included in the processor 134 of the controller 130.

Specifically, referring to FIG. 6, the host controller 510 may check the first to third information stored in the information storage 530 at operation 5101.

The host controller 510 may switch or change the state of the memory system 110 to a busy state in response to entry into the automatic exclusive mode at the start of the automatic exclusive mode, which can be recognized by checking the first to third information of the information storage 530 through operation 5101. The host controller 510 may inform the host 102 of the switched state at operation 5102.

Since the host 102 recognizes through operation 5102 of the host controller 510 that the memory system 110 is busy, the host controller 510 may not receive an arbitrary request such as a read request or a write request from the host 102 in the entry period of the automatic exclusive mode.

The host controller 510 may switch the state of the memory system 110 to a ready state in response to an exit from the automatic exclusive mode in the start period of the automatic exclusive mode, which can be recognized by checking the first to third information stored in the information storage 530 through operation 5101. The host controller 510 may inform the host 102 of the switched state (i.e., the ready state) at operation 5103.

Since the host 102 recognizes through operation 5103 of the host controller 510 that the memory system 110 is ready, the host controller 510 may receive an arbitrary request such as a read request or a write request from the host 102 after exiting from the automatic exclusive mode.

The host controller 510 may request the memory controller 520 to start the automatic exclusive mode in response to a request for a merge operation from the host 102 at operation 5104.

The host controller 510 requests the memory controller 520 to start the automatic exclusive mode through operation 5104 because the host controller 510 can only check the first to third information stored in the information storage 530 through operation 5101. The host controller 510 cannot adjust the first to third information stored in the information storage 530. That is, only the memory controller 520 may have an authority to adjust the first to third information stored in the information storage 530.

Referring to FIG. 7, the memory controller 520 may check the first to third information stored in the information storage 530 at operation 5204.

The memory controller 520 may repeatedly enter/exit from the automatic exclusive mode in each set cycle of the automatic exclusive mode, which can be recognized in response to the result obtained by checking the first to third information of the information storage 530 through operation 5204.

Specifically, the memory controller 520 may check whether the automatic exclusive mode was started, by referring to the first information stored in the information storage 530.

When the result obtained by checking the first information stored in the information storage 530 indicates that the automatic exclusive mode was started, the memory controller 520 may check the repeated entry and exit points of the automatic exclusive mode by referring to the second and third information. That is, according to the results obtained by checking the second and third information of the information storage 530, the memory controller 520 may repeatedly enter the automatic exclusive mode at the repeated entry points of the automatic exclusive mode. The memory controller 520 may repeatedly exit from the automatic exclusive mode at the repeated exit points of the automatic exclusive mode.

The entry points of the automatic exclusive mode, defined by the second information stored in the information storage 530, may be decided based on a specific time interval which may vary depending on the second information. For example, the specific time interval may be set in the range of 10 ms to 100 ms depending on the second information.

The entry points of the automatic exclusive mode, defined by the second information stored in the information storage 530, may be decided based on a specific size of write data which are transferred from the host 102 and can be varied depending on the second information. For example, the specific size of the write data may be set in the range of 128 to 512 Kbyte, depending on the second information.

The memory controller 520 may adjust the values of the first to third information stored in the information storage 530, in response to at least one of a request of the host controller 510 or a result obtained by checking the state of the nonvolatile memory 150, at operations 5201, 5202, 5203.

Specifically, the memory controller 520 may adjust the first information stored in the information storage 530 and determine whether to start, maintain and/or exit the automatic exclusive mode, according to the following two conditions.

According to the first condition of the memory controller 520, the memory controller 520 may check the ratio of free memory blocks among the memory blocks BLOCK<1:6> in the nonvolatile memory 150, based on a set ratio. The memory controller 520 may determine whether to start the automatic exclusive mode by adjusting the first information stored in the information storage 530 according to the check result, at operation 5201.

When the check result for the first condition through operation 5201 indicates that the ratio of free memory blocks is equal to or less than the set ratio, the memory controller 520 may set the first information stored in the information storage 530 to the start state. Thus, the memory controller 520 can continuously retain the automatic exclusive mode when the automatic exclusive mode was already started. Or, the memory controller 520 can start the automatic exclusive mode when the automatic exclusive mode was ended.

When the check result for the first condition through operation 5201 indicates that the ratio of free memory blocks exceeds the preset ratio, the memory controller 520 may adjust the first information stored in the information storage 530 to the end state. Thus, the memory controller 520 may end the automatic exclusive mode when the automatic exclusive mode was already started. Or, the memory controller 520 can continuously retain the end state of the automatic exclusive mode when the automatic exclusive mode was ended.

According to the second condition of the memory controller 520, the memory controller 520 may set the first information stored in the information storage 530 to the start state in response to a request received through operation 5104 of the host controller 510, described with reference to FIG. 6, at operation 5202.

Thus, according to the second condition through operation 5202, the memory controller 520 can continuously retain the automatic exclusive mode when the automatic exclusive mode was already started. Or, the memory controller 520 can start the automatic exclusive mode when the automatic exclusive mode was ended.

Furthermore, according to a result obtained by checking the state of the nonvolatile memory 150 in the start period of the automatic exclusive mode, the memory controller 520 may adjust the second or third information stored in the information storage 530.

Specifically, when entering the automatic exclusive mode to perform a merge operation at the start of the automatic exclusive mode, the memory controller 520 may check the total number of valid pages in victim memory blocks among the memory blocks BLOCK<1:6> in the nonvolatile memory 150, based on a set number. The memory controller 520 may adjust the second or third information stored in the information storage 530 according to the check result at operation 5203.

During the merge operation, when the total number of valid pages in the victim memory blocks among the memory blocks BLOCK<1:6> in the nonvolatile memory 150 is equal to or more than the set number, the memory controller 520 may adjust the second information stored in the information storage 530, such that the entry point of the automatic exclusive mode through operation 5205, that is, the set cycle is more frequently repeated.

During the merge operation, when the total number of valid pages in the victim memory blocks among the memory blocks BLOCK<1:6> in the nonvolatile memory 150 is less than the preset number, the memory controller 520 may adjust the second information stored in the information storage 530, such that the entry point of the automatic exclusive mode through operation 5205, that is, the set cycle is less frequently repeated.

During the merge operation, when the total number of valid pages in the victim memory blocks among the memory blocks BLOCK<1:6> in the nonvolatile memory 150 is equal to or more than the set number, the memory controller 520 may adjust the third information stored in the information storage 530 to increase the length of the automatic exclusive mode from the entry point to the exit point, that is, the length of the entry period of the automatic exclusive mode through operation 5205.

During the merge operation, when the total number of valid pages in the victim memory blocks among the memory blocks BLOCK<1:6> in the nonvolatile memory 150 is less than the set number, the memory controller 520 may adjust the third information stored in the information storage 530 to decrease the length of the automatic exclusive mode from the entry point to the exit point, that is, the length of the entry period of the automatic exclusive mode through operation 5205.

For reference, the memory controller 520 may adjust one or both of the second or third information stored in the information storage 530 through one adjusting operation. The adjusting operation of the memory controller 520 to adjust the second and/or third information stored in the information storage 530 may be changed depending on a designer's selection.

Then, the memory controller 520 may flush the data stored in the volatile memory 144 to the nonvolatile memory 150 in response to the entry into the automatic exclusive mode through operation 5205 at the start of the automatic exclusive mode through operation 5201, at operation 5206.

In this case, the memory controller 520 may exclusively use the entire region of the volatile memory 144 to perform a merge operation during the entry period of the automatic exclusive mode.

The operation of flushing the data stored in the volatile memory 144 to the nonvolatile memory 150 may indicate that all of the data stored in the volatile memory 144 are copied and stored into a set region of the nonvolatile memory 150. For this reason, the memory controller 520 may discard the data stored in the volatile memory 144 after the flush operation. The memory controller 520 may exclusively use the entire region of the volatile memory 144 to perform the merge operation.

Furthermore, the memory controller 520 may discard data updated into the nonvolatile memory 150 among the data stored in the volatile memory 144, in response to the entry into the automatic exclusive mode through operation 5205 in the start period of the automatic exclusive mode through operation 5201, at operation 5207.

In this case, the memory controller 520 can exclusively use a wider region than a region designated for a general merge operation in the volatile memory 144, to perform the merge operation during the entry period of the automatic exclusive mode.

As described above with reference to FIG. 1, the volatile memory 144 can be used for various uses, for example, a write buffer/cache, a read buffer/cache and a map buffer/cache. Generally, the internal storage space of the volatile memory 144 may be divided into various regions depending on the uses. However, some of the internal storage space of the volatile memory 144 may be designated for a merge operation in advance.

The memory controller 520 in accordance with an embodiment may discard data updated into the nonvolatile memory 150 among data stored in regions which are not previously designated for a merge operation in the storage space of the volatile memory 144, in response to the entry into the automatic exclusive mode. Therefore, the memory controller 520 in accordance with an embodiment can exclusively use a wider region than the region designated for a general merge operation in the volatile memory 144, to perform the merge operation during the entry period of the automatic exclusive mode.

The data updated into the nonvolatile memory 150 among the data stored in the volatile memory 144 may indicate data which are already stored in the nonvolatile memory 150 through an operation such as a checkpoint, among the data stored in the volatile memory 144. For this reason, the memory controller 520 can discard the data updated into the nonvolatile memory 150 among the data stored in the volatile memory 144 in the entry period of the automatic exclusive mode. The memory controller 520 can use the corresponding region (i.e., region previously storing discarded data and now ready to be reallocated) for the merge operation.

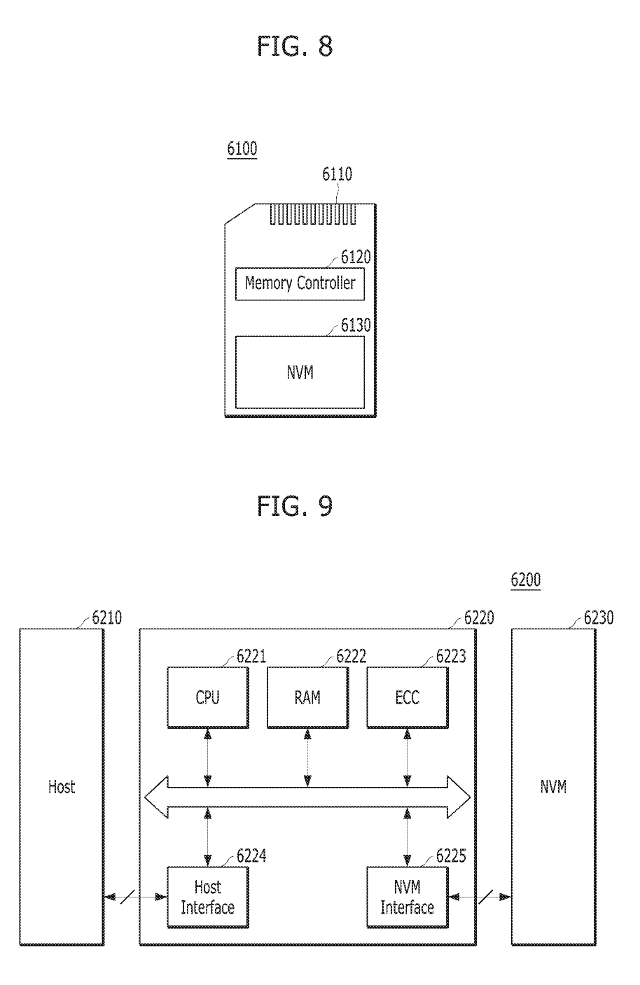

FIGS. 8 to 16 are diagrams schematically illustrating exemplary applications of the data processing system of FIG. 1.

FIG. 8 is a diagram schematically illustrating another example of the data processing system including the memory system in accordance with an embodiment. FIG. 8 schematically illustrates a memory card system to which the memory system may be applied.

Referring to FIG. 8, the memory card system 6100 may include a memory controller 6120, a memory device 6130 and a connector 6110.

The memory controller 6120 may be connected to the memory device 6130 embodied by a nonvolatile memory and configured to access the memory device 6130. For example, the memory controller 6120 may be configured to control read, write, erase and background operations of the memory device 6130. The memory controller 6120 may be configured to provide an interface between the memory device 6130 and a host, and use firmware for controlling the memory device 6130. That is, the memory controller 6120 may correspond to the controller 130 of the memory system 110 described with reference to FIGS. 1 and 5, and the memory device 6130 may correspond to the memory device 150 of the memory system 110 described with reference to FIGS. 1 and 5.

Thus, the memory controller 6120 may include a RAM, a processor, a host interface, a memory interface and an error correction component. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device according to one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with an embodiment may be applied to wired/wireless electronic devices, particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5.

The memory controller 6120 and the memory device 6130 may be integrated into a single semiconductor device to form a solid state driver (SSD). Also, the memory controller 6120 and the memory device 6130 may be so integrated to form a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and/or a universal flash storage (UFS).

FIG. 9 is a diagram schematically illustrating another example of the data processing system including the memory system in accordance with an embodiment.

Referring to FIG. 9, the data processing system 6200 may include a memory device 6230 having one or more nonvolatile memories and a memory controller 6220 for controlling the memory device 6230. The data processing system 6200 illustrated in FIG. 9 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 5. The memory controller 6220 may correspond to the controller 130 in the memory system 110 illustrated in FIGS. 1 and 5.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC component 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224. The memory controller 6220 may transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. As the memory controller 6220 is configured to communicate with the external device through one or more of various communication protocols, the memory system and the data processing system in accordance with an embodiment may be applied to wired/wireless electronic devices, or particularly a mobile electronic device.

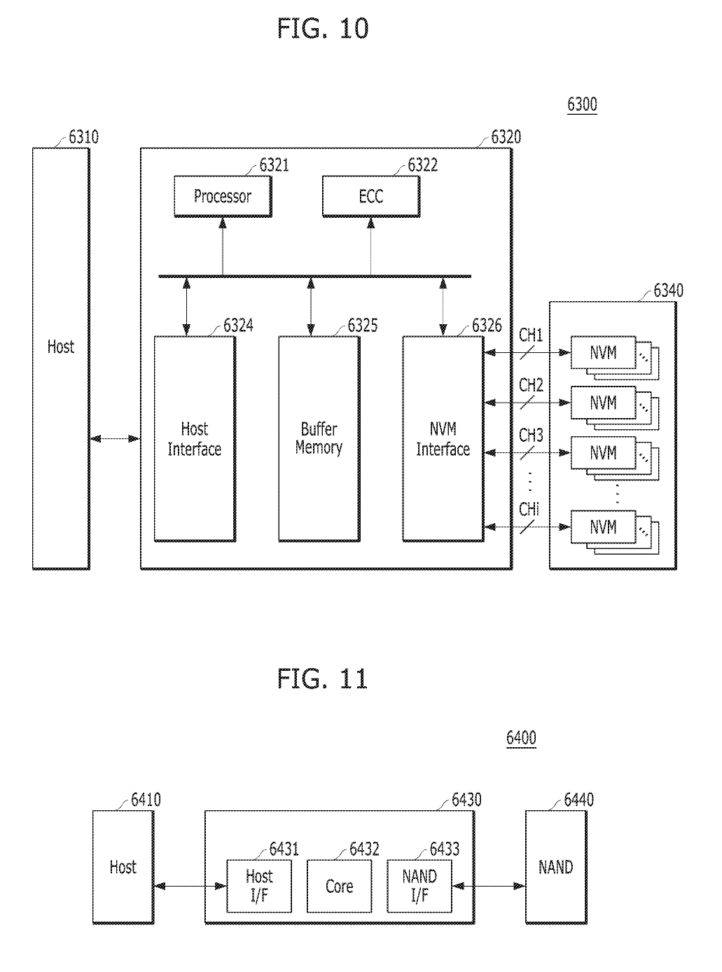

FIG. 10 is a diagram schematically illustrating another example of the data processing system including the memory system in accordance with an embodiment. FIG. 10 schematically illustrates an SSD to which the memory system may be applied.

Referring to FIG. 10, the SSD 6300 may include a controller 6320 and a memory device 6340 including a plurality of nonvolatile memories. The controller 6320 may correspond to the controller 130 in the memory system 110 of FIGS. 1 and 5. The memory device 6340 may correspond to the memory device 150 in the memory system of FIGS. 1 and 5.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, is map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. By way of example, FIG. 9 illustrates that the buffer memory 6325 is in the controller 6320. However, the buffer memory 6325 may be disposed external to the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. The RAID system may include the plurality of SSDs 6300 and a RAID controller for controlling the plurality of SSDs 6300. When the RAID controller performs a is program operation in response to a write command provided from the host 6310, the RAID controller may select one or more memory systems or SSDs 6300 according to a plurality of RAID levels, that is, RAID level information of the write command provided from the host 6310 in the SSDs 6300. The RAID controller may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300. The RAID controller may provide data read from the selected SSDs 6300 to the host 6310.

FIG. 11 is a diagram schematically illustrating another example of the data processing system including the memory system in accordance with an embodiment. FIG. 11 schematically illustrates an embedded Multi-Media Card (eMMC) to which the memory system may be applied.

Referring to FIG. 11, the eMMC 6400 may include a controller 6430 and a memory device 6440 embodied by one or more NAND flash memories. The controller 6430 may correspond to the controller 130 in the memory system 110 of FIGS. 1 and 5. The memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

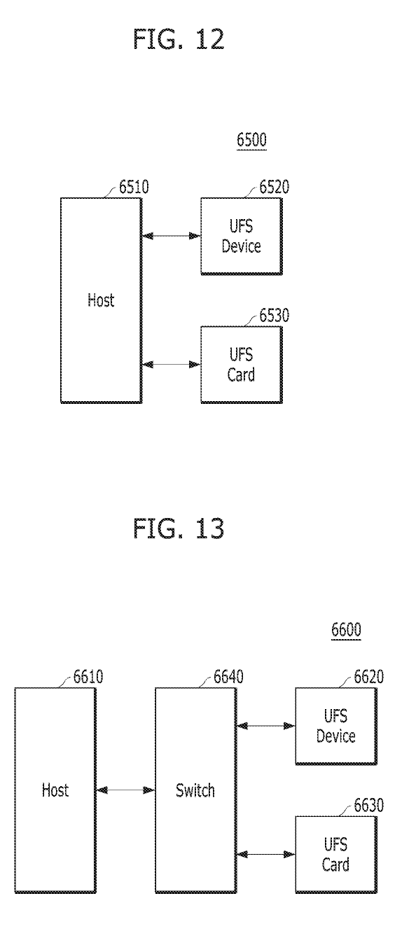

FIGS. 12 to 15 are diagrams schematically illustrating other examples of the data processing system including the memory system in accordance with an embodiment. FIGS. 12 to 15 schematically illustrate UFS (Universal Flash Storage) systems to which the memory system may be applied.

Referring to FIGS. 12 to 15, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIGS. 1 and 5. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 9 to 11, and the UFS cards 6530, 6630, 6730, 6830 may be embodied in the form of the memory card system 6100 described with reference to FIG. 8.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, UFDs, MMC, SD, mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410. A star formation is an arrangement in which a single centralized component is coupled to multiple devices for parallel processing. A plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. A configuration in which one UFS device 6620 and one UFS card 6630 are connected to the switching module 6640 is illustrated for clarity. However, a plurality of UFS devices and UFS cards may be connected in parallel or in the form of a star to the switching module 6640, and a plurality of UFS cards may be connected in series or in the form of a chain to the UFS device 6620.

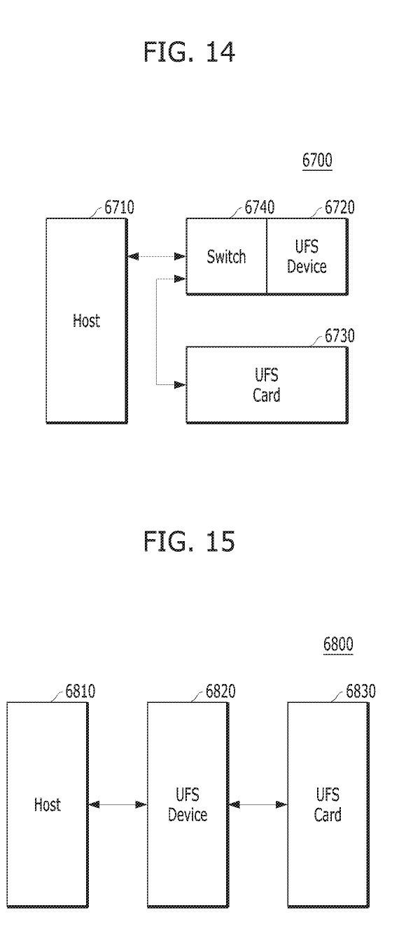

In the UFS system 6700 illustrated in FIG. 14, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. The host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

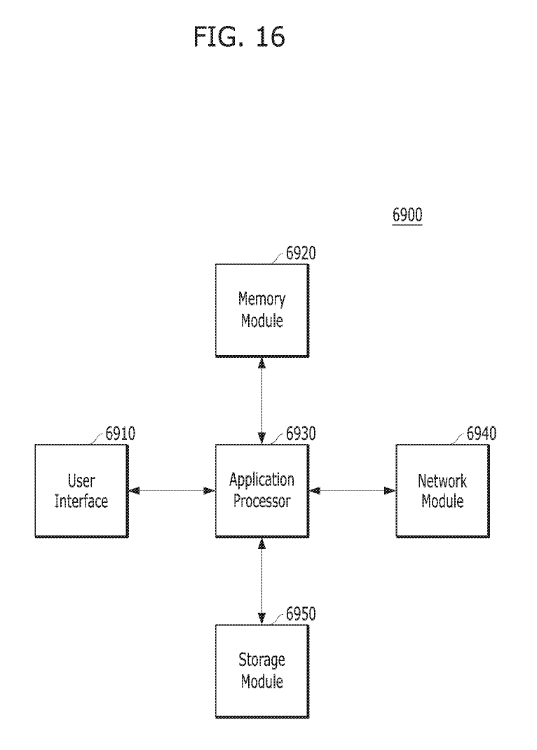

FIG. 16 is a diagram schematically illustrating another example of the data processing system including the memory system in accordance with an embodiment. FIG. 16 is a diagram schematically illustrating a user system to which the memory system may be applied.

Referring to FIG. 16, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device. The network module 6940 may serve as a communication module for controlling wired/wireless communication with an external device. The user interface 6910 may display data processed by the processor 6930 on a display/touch module of the mobile electronic device. The user interface 6910 may support a function of receiving data from the touch panel.

In accordance with embodiments, the memory system may allow exclusive use of the volatile memory to perform a merge operation in the entry period of the automatic exclusive mode, thereby enhancing or maximizing the performance of the merge operation.

The memory system may select whether to start/end the automatic exclusive mode in response to a request of the host or a result obtained by checking the state of the nonvolatile memory, such that an entry into/exit from the automatic exclusive mode can be automatically repeated in each cycle in the start period of the automatic exclusive mode. Through this operation, the entry/exit points of the automatic exclusive mode can be accurately adjusted.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a nonvolatile memory comprising a plurality of memory blocks, each including a plurality of pages;
a volatile memory suitable for temporarily storing data transferred between a host and the nonvolatile memory; and
a controller suitable for determining whether to start or end an automatic exclusive mode in response to a request from the host or a result obtained by checking a state of the nonvolatile memory, repeatedly entering into, or exiting from, the automatic exclusive mode in each set cycle when the automatic exclusive mode is started, and exclusively using the volatile memory to perform a merge operation on the nonvolatile memory during an entry period of the automatic exclusive mode in each set cycle.

2. The memory system of claim 1, further comprising an information storage suitable for storing first information on start and end states of the automatic exclusive mode, second information on the set cycle, and third information on the length of the entry period of the automatic exclusive mode.

3. The memory system of claim 2, wherein the controller comprises:
a host controller suitable for processing an operation between the host and the host controller;
a memory controller coupled to the host controller, and suitable for processing an operation between the nonvolatile memory and the memory controller, and
wherein the memory controller adjusts values of the first to third information in response to the request of the host or the result obtained by checking the state of the nonvolatile memory.

4. The memory system of claim 3, wherein the memory controller checks the ratio of free memory blocks among the memory blocks, and sets the first information to a start state when the ratio of free memory blocks is equal to or less than a set ratio, and sets the first information to an end state when the ratio of free memory blocks exceeds the set ratio.

5. The memory system of claim 4, wherein the host controller requests the memory controller to start the automatic exclusive mode in response to a request for the merge operation from the host, and
the memory controller sets the first information to the start state in response to the request from the host controller.

6. The memory system of claim 5, wherein the memory controller checks a total number of valid pages in victim memory blocks among the memory blocks when performing the merge operation at the start of the automatic exclusive mode,
wherein when the total number of valid pages is equal to or more than a set number, the memory controller adjusts the second information such that the set cycle is more frequently repeated, or adjusts the third information to increase the length of the entry period of the automatic exclusive mode, and
when the total number of valid pages is less than the set number, the memory controller adjusts the second information such that the set cycle is less frequently repeated, or adjusts the third information to decrease the length of the entry period of the automatic exclusive mode.

7. The memory system of claim 6, wherein the host controller checks the first to third information, and informs the host of a switchover to a busy state in response to an entry into the automatic exclusive mode based on the check result, or informs the host of a switchover to a ready state in response to an exit from the automatic exclusive mode based on the check result.

8. The memory system of claim 3, wherein the memory controller checks the first to third information, repeatedly enters into, and exits from, the automatic exclusive mode in each set cycle based on the check result, and exclusively uses the nonvolatile memory to perform the merge operation on the nonvolatile memory during the entry period of the automatic exclusive mode in each set cycle.

9. The memory system of claim 8, wherein the memory controller flushes the data stored in the volatile memory to the nonvolatile memory in response to entry into the automatic exclusive mode, and exclusively uses the volatile memory to perform the merge operation on the nonvolatile memory during the entry period of the automatic exclusive mode in each set cycle.

10. The memory system of claim 8, wherein the memory controller discards data updated into the nonvolatile memory among the data stored in the volatile memory in response to entry into the automatic exclusive mode, and exclusively uses the volatile memory to perform the merge operation on the nonvolatile memory during the entry period of the automatic exclusive mode in each set cycle.

11. An operation method of a memory system which includes a nonvolatile memory including a plurality of blocks, each having a plurality of pages, and a volatile memory for temporarily storing data transferred between a host and the nonvolatile memory, the operation method comprising:
determining whether to start or end an automatic exclusive mode in response to a request from the host or a result obtained by checking a state of the nonvolatile memory, and repeatedly entering into, and exiting from, the automatic exclusive mode in each set cycle when the automatic exclusive mode is started; and
exclusively using the volatile memory to perform a merge operation on the nonvolatile memory during the entry period of the automatic exclusive mode in each set cycle.

12. The operation method of claim 11, wherein the memory system further includes an information storage suitable for storing first information on start and end states of the automatic exclusive mode, second information on the set cycle, and third information on the length of the entry period of the automatic exclusive mode.

13. The operation method of claim 12, wherein the memory system further includes a host controller suitable for processing an operation between the host and the host controller and a memory controller coupled to the host controller and suitable for processing an operation between the nonvolatile memory and the memory controller, and
the determining step comprises adjusting the first to third information through the memory controller in response to the request of the host or the result obtained by checking the state of the nonvolatile memory.

14. The operation method of claim 13, wherein the adjusting step comprises:
checking the ratio of free memory blocks among the memory blocks;
setting the first information to the start state by the memory controller, when the ratio of free memory blocks is equal to or less than a set ratio; and
setting the first information to the end state by the memory controller, when the ratio of free memory blocks exceeds the set ratio.

15. The operation method of claim 14, wherein the determining step further comprises requesting, by the host controller, the memory controller to start the automatic exclusive mode, when the host requests the host controller to perform the merge operation, and
the adjusting step further comprises setting the first information to the start state by the memory controller in response to the requesting step.

16. The operation method of claim 15, wherein the adjusting step comprises:
checking the total number of valid pages in victim memory blocks among the memory blocks when performing the merge operation by the memory controller at the start of the automatic exclusive mode;
adjusting the second information by the memory controller such that the set cycle is more frequently repeated, or adjusting the third information to increase the length of the entry period of the automatic exclusive mode, when the total number of valid pages is equal to or more than a set number; and
adjusting the second information by the memory controller such that the set cycle is less frequently repeated, or adjusting the third information to decrease the length of the entry period of the automatic exclusive mode, when the total number of valid pages is less than the set number.

17. The operation method of claim 16, wherein the determining step comprises:
checking the first to third information;
informing, by the host controller, the host that the memory system is switched to a busy state, in response to an entry into the automatic exclusive mode based on the result of checking the first to third information; and
informing, by the host controller, the host that the memory system is switched to a ready state, in response to an exit from the automatic exclusive mode based on the result of checking the first to third information.

18. The operation method of claim 13, wherein the determining step comprises:
checking, by the memory controller, the first to third information; and
performing a repeating step in which the memory controller repeatedly enters into, and exits from the automatic exclusive mode in each set cycle at the start of the automatic exclusive mode based on the checking of the first to third information.

19. The operation method of claim 18, further comprising performing, by the memory controller, the exclusively using step after flushing the data stored in the volatile memory to the nonvolatile memory in response to the entry into the automatic exclusive mode in each set cycle through the repeating step.

20. The operation method of claim 18, further comprising performing, by the memory controller, the exclusively using step after discarding data updated into the nonvolatile memory among data stored in the volatile memory in response to the entry into the automatic exclusive mode in each set cycle through the repeating step.
